(19) United States
(12) Patent Application Publication
(10) Pub. No.: US 2021/0044459 A1
(43) Pub. Date: Feb. 11, 2021

(54) Self-Evaluating High Frequency, Bandwidth, And Dynamic Range Cellular Polar Transmit Signal Fidelity

(71) Applicant: APPLE INC., Cupertino, CA (US)

(72) Inventors: Andrew RACLAW, Tempe, AZ (US); Anamul HOQUE, Chandler, AZ (US); David NEWMAN, Tempe, AZ (US); Stephen RECTOR, Tempe, AZ (US)

(73) Assignee: Apple Inc., Cupertino, CA (US)

(21) Appl. No.: 16/976,537

(22) PCT Filed: Mar. 30, 2018
(86) PCT No.: PCT/US2018/025525

§ 371 Date: Aug. 28, 2020

(51) Int. Cl. H04L 25/02; H04B 17/24; H04L 27/36; H04B 17/00

(52) U.S. Cl. CPC H04L 25/0264; H04B 17/0085; H04L 27/366; H04B 17/24

(57) ABSTRACT

A radio communication device includes a device substrate. A transmitter circuit is coupled to the device substrate to transmit a radio frequency signal to an antenna. The radio communication device also includes a receiver circuit coupled to the device substrate, where the receiver circuit includes an oscillator circuit to generate a baseband signal from a received radio frequency signal. The radio communication device further includes a feedback circuit coupled to the antenna and to the receiver circuit, where the feedback circuit couples a portion of the transmitted radio frequency signal to the oscillator circuit using a transmission line.

### TECHNICAL FIELD

Aspects described herein generally relate to radio communication circuits, and in particular, to evaluating polar modulated transmission signals.

### BACKGROUND

There has been a rapid proliferation of electronic devices that rely on radio frequency based wireless communication techniques. Such devices can include laptops, tablet computers, cellular telephones, and even general household appliances. As these devices become more deeply networked and continue to produce and consume increasing amounts of data, the demand for usable bands on the radio frequency spectrum will increase. Consequently, radio frequency communication circuits are being designed to enable high bandwidth communication over an increasingly wide range of the radio frequency spectrum. As an example, a new wireless communication standard, such as 5^{th} generation (5G) wireless communication standard, devices can be expected to provide high bandwidth communication at frequencies ranging from less than 1 gigahertz (GHz) to frequencies in excess of 5 GHz. Current techniques for testing the quality or fidelity of, for example, a transmit circuit in such devices can be expensive in terms of required test equipment and testing time, making these techniques ill-suited for certain manufacturing or production processes.

### BRIEF DESCRIPTION OF THE DRAWINGS

In the drawings, which are not necessarily drawn to scale, like numerals may describe similar components in different views. Like numerals having different letter suffixes may represent different instances of similar components. Some aspects are illustrated by way of example, and not limitation, in the figures of the accompanying drawings in which:

FIG. 1A illustrates a diagram of an example of a millimeter wave communication device having circuits for self-evaluating the fidelity of a radio frequency transmit signal, according to some aspects;

FIG. 1B illustrates aspects of an example of transmit circuitry illustrated in FIG. 1A, according to some aspects;

FIG. 1C illustrates aspects of an example of transmit circuitry illustrated in FIG. 1A according to some aspects;

FIG. 1D illustrates aspects of an example of receive circuitry in FIG. 1A according to some aspects;

FIG. 2 illustrates a diagram an example of a millimeter wave communication device having circuits for self-evaluating the fidelity of a radio frequency transmit signal, according to some aspects;

FIG. 3 illustrates a flowchart of a set of operations for operating a millimeter wave communication device having circuits for self-evaluating the fidelity of a radio frequency transmit signal, according to some aspects;

FIG. 4 illustrates a diagram of an example of a wideband low-noise amplifier for driving a transmission line, according to some aspects;

FIG. 5 illustrates a diagram of an example of a line driver within an output stage of low-noise amplifier, according to some aspects;

FIG. 6 illustrates a flowchart of a set of operations for operating a line driver within an output stage of low-noise amplifier, according to some aspects;

FIG. 7 is a block diagram illustrating an example of an electronic device that includes a radio communication device, such as a transceiver having circuits for self-evaluating the fidelity of a radio frequency transmit signal, according to some aspects; and

FIG. 8 illustrates an example of a base station or infrastructure equipment radio head according to some aspects.

### DETAILED DESCRIPTION

In the following description, for purposes of explanation, numerous specific details are set forth in order to provide a thorough understanding of some example aspects. It will be evident, however, to one skilled in the art that the present disclosure may be practiced without these specific details.

Radio frequency communication devices can include a transceiver, such as one or more circuits in an integrated circuit package for transmitting and receiving radio frequency (RF) signals. Such a transceiver can include a receive signal chain, such as one or more circuits for receiving an RF signal from an antenna and converting it to a digital baseband signal. Such a transceiver can also include a transmit signal chain, such as one or more circuits for converting a digital baseband signal to a RF signal for transmission to an antenna. Some transmit signal chains can have artifacts, characteristics, or defects, that distort or otherwise degrade the quality of an RF signal transmitted to an antenna. A transmit signal chain, for example, can have one or more amplifiers, such as a power amplifier at the output of the transmit signal chain, that can introduce distortions due to nonlinearities in the output of the amplifier.

In some aspects, the fidelity of a RE transmit (RF Tx) signal generated by a transmit signal chain of a transceiver circuit can be evaluated by sampling the RF Tx signal at the output of the signal chain as it is transmitted to an antenna, down-converting the sampled RF Tx signal to a baseband signal using a local oscillator in a receive signal chain of the transceiver circuit, and processing the baseband signal characterize the fidelity of the RF Tx signal. In some transceivers, such as a transceiver that uses polar modulation, the transmit signal chain and the receive signal chain can each use distinct local oscillators, such as for converting a signal from one frequency band to another frequency band. In the case of transceiver configured to generate or receive polar modulated RF signals, the local oscillator associated with the transmit signal chain can be modulated with phase modulation data. This modulated local oscillator cannot be used to down-convert a sampled polar modulated RE Tx signal without degrading or destroying data contained in the signal. The receive signal chain in these transceivers, however, typically includes unmodulated local oscillators that are configured to down-convert polar modulated RF signals. Accordingly and in some aspects, the receive signal chain in a transceiver configured to operate on polar modulated RF signals can be used to convert a sampled RF Tx signal to a digital baseband signal, such as to enable local processing and evaluation of the transmit signal chain. According to techniques described herein, a sampled RF Tx signal can be transmitted over a physical transmission line, such as from a side of transceiver chip or package having the output of the transmit signal chain, to an input of the receive signal chain. The transmission line can several millimeters (mm) long, and can have an electrical length that varies considerably with the frequency, or wavelength, of the sampled RF Tx signal. In some aspects, the transmission line can be a differential transmission line, such as to reduce interference from external signals, or a single ended transmission line.

In some aspects, wideband line driver can be constructed using a source follower based on a field-effect-transistor (ITT), or similar transconductor device. Such a line driver can include a local negative feedback loop, so as to enable the output characteristics of the line driver to be adjusted in response to a frequency of an input signal, such as for allowing the peaking frequency and the peaking amplitude of the line driver to be independently controlled. Such a line-driver can be useful for driving a transmission line with RF signals having frequencies that can vary by two or more octaves. The adjustable peaking capability can be used to counteract the frequency dependent rolloff of the transmission line.

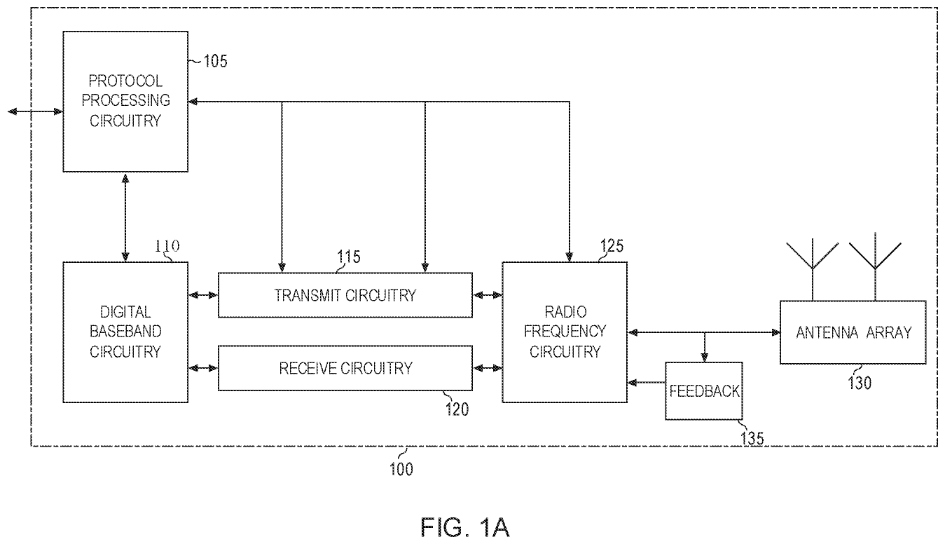

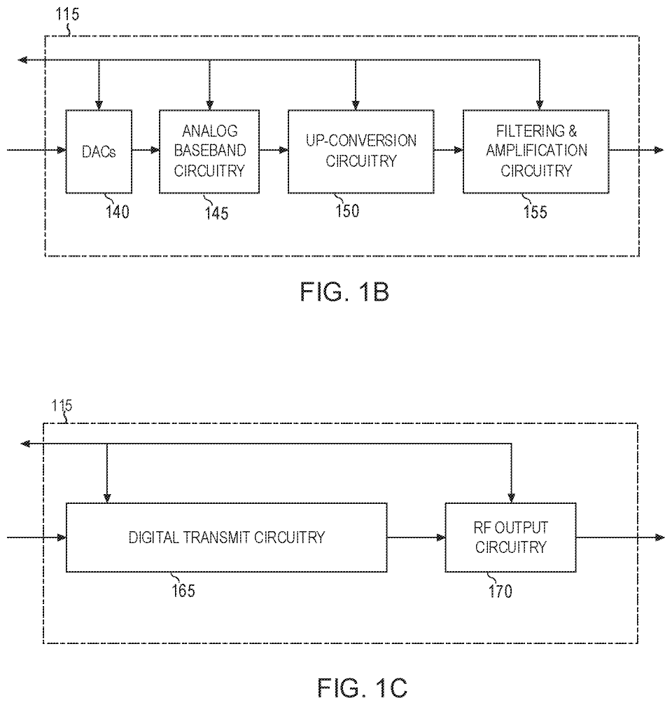

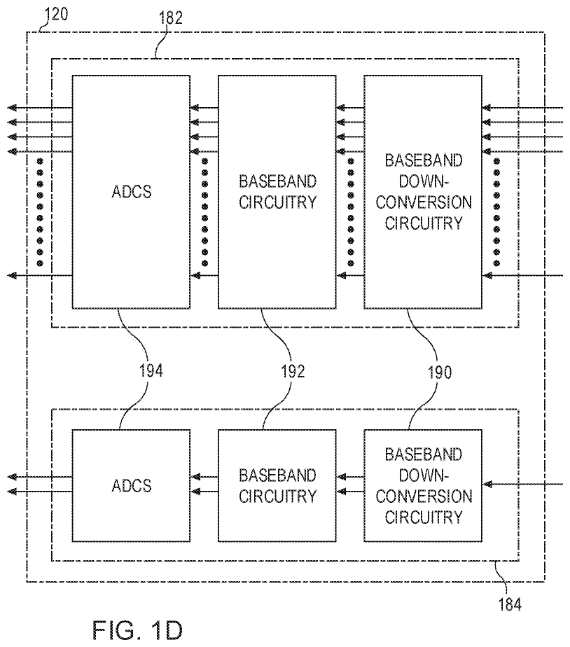

FIG. 1A illustrates an example of a diagram of a millimeter wave communication device having circuits for self-evaluating the fidelity of an RE transmit signal, according to some aspects. As used herein, millimeter wave communication devices can include devices configured to communicate at frequencies having millimeter and sub-millimeter wavelengths. The millimeter wave communication circuitry 100 shown in FIG. 1A may be alternatively grouped according to functions. Components illustrated in FIG. 1A are provided here for illustrative purposes and may include other components not shown in FIG. 1A.

The millimeter wave communication circuitry 100 may include protocol processing circuitry 105 (or processor) or other means for processing. The protocol processing circuitry 105 may implement one or more of medium access control (MAC), radio link control (RLC), packet data convergence protocol (PDCP), radio resource control (RRC) and non-access stratum (NAS) functions, among others. The protocol processing circuitry 105 may include one or more processing cores to execute instructions and one or more memory structures to store program and data information.

Millimeter wave communication circuitry 100 may further include digital baseband circuitry 110. Digital baseband circuitry 110 may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency, or spatial coding, reference signal generation and/or detection, preamble sequence generation and/or decoding, synchronization sequence generation and/or detection, control channel signal blind decoding, and other related functions.

Millimeter wave (mmWave) communication circuitry 100 may further include transmit circuitry 115, receive circuitry 120, and/or antenna array circuitry 130. In some aspects, the transmit circuitry 115 and the receive circuitry 120 can be constructed on a single device substrate. Millimeter wave communication circuitry 100 may further include RF circuitry 125. In some aspects, RF circuitry 125 may include one or multiple parallel RF chains for transmission and/or reception. Each of the RF chains may be connected to one or more antennas of antenna array circuitry 130. Such RF chains can include one or more filters, power amplifiers, low noise amplifiers, programmable phase shifters and power supplies. Transmit circuitry 115 and receive circuitry 120 can be examples of a transmit signal chain and receive signal chain, respectively. In some aspects, the transmit signal chain can include portions of RF circuitry 125, such as a power amplifier for amplifying an RF signal before transmission to the antenna array 130.

In some aspects, protocol processing circuitry 105 may include one or more instances of control circuitry. The control circuitry may provide control functions for one or more of digital baseband circuitry 110, transmit circuitry 115, receive circuitry 120, RF circuitry 125, and a feedback circuit 135.

In some aspects, the control circuitry can include circuits or computer executable code to control the receive circuitry 120, such as to cause a mixer circuit in the receive circuitry to select between down-converting an RF signal received from the feedback circuit 135 and an RF signal received from a receive antenna or circuit in a normal transceiver receive signal path, such as to select the RF signal received from the feedback circuit 135 during a test mode or while executing a testing operation. The control circuitry 105 can also include circuits or computer executable code to process a baseband signal, or data retrieved from a baseband signal, to during the test mode, such as to determine the fidelity of a RF Tx generated by transmit circuitry 115. Such processing can include comparing the data retrieved from a baseband signal derived from a RF signal received from the feedback circuit 135 to data used to modulate the received RE signal. In some aspects, such processing can also include modifying an behavior or operation of the digital baseband circuitry 110 or transmit circuit 115 in response to the comparison, such as to improve the fidelity of RE Tx generated by the transmit circuitry 115. In other aspects, such processing can include providing an indication of the fidelity of the RF Tx signal to an external circuit or device.

FIG. 1B and FIG. 1C illustrate aspects of transmit circuitry shown in FIG. 1A according to some aspects. Transmit circuitry 115 shown in FIG. 1B may include one or more of digital to analog converters (DACs) 140, analog baseband circuitry 145, up-conversion circuitry 150, and/or filtering and amplification circuitry 155. DACs 140 may convert digital signals into analog signals. Analog baseband circuitry 145 may perform multiple functions as indicated below. Up-conversion circuitry 150 can include a phase modulated local oscillator and a mixer circuit, such as to up-convert baseband signals from analog baseband circuitry 145 to RF frequencies (e.g., mmWave and sub-mmWave frequencies). Such RF frequencies can include polar modulated RF signals. Filtering and amplification circuitry 155 may filter and amplify analog signals. Control signals may be supplied between protocol processing circuitry 105 and one or more of DACs 140, analog baseband circuitry 145, up-conversion circuitry 150 and/or filtering and amplification circuitry 155.

Transmit circuitry 115 shown in FIG. 1C may include digital transmit circuitry 165 and RF circuitry 170. In some aspects, signals from filtering and amplification circuitry 155 may be provided to digital transmit circuitry 165. As above, control signals may be supplied between protocol processing circuitry 105 and one or more of digital transmit circuitry 165 and RF circuitry 170.

FIG. 1D illustrates aspects of receive circuitry in FIG. 1A according to some aspects. Receive circuitry 120 may include one or more of parallel receive circuitry 182 and/or one or more of combined receive circuitry 184. In some aspects, the one or more parallel receive circuitry 182 and one or more combined receive circuitry 184 may include one or more baseband down-conversion circuitry 190. Baseband processing circuitry 192 and analog-to-digital converter (ADC) circuitry 194. Baseband down-conversion circuitry 190 can include an unmodulated local oscillator coupled to a mixer circuit, such as to convert received RF signals to baseband. Baseband processing circuitry 192 may process the baseband signals, e.g., via filtering and amplification. ADC circuitry 194 may convert the processed analog baseband signals to digital signals.

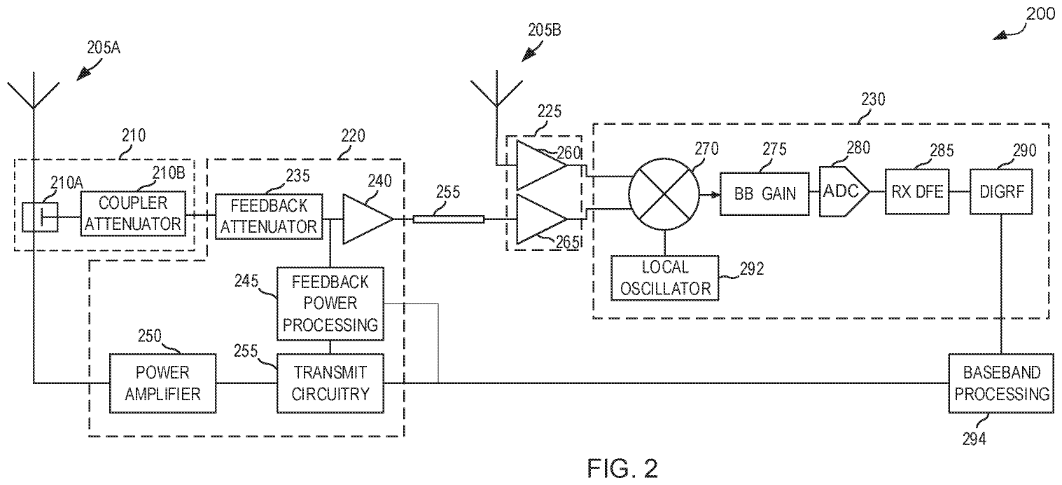

FIG. 2 illustrates a diagram an example of a millimeter wave communication device 200 having circuits for self-evaluating the fidelity of a radio frequency transmit signal, according to some aspects. The millimeter wave communication device 200 can include a coupler 210, a transmit signal chain 220, a transmission line 255, RF circuitry 225, receive signal chain 230, and baseband processing circuitry 294. The millimeter wave communication device 200 can be an example of the millimeter wave communication device 100 (FIG. 1A). In some aspects, the transmit signal chain 220, the transmission line 255. RF circuitry 225, and the receive signal chain 230 can be implemented or constructed on a single device substrate or in a single device package. In some aspects, the millimeter wave communication device 200 can be configured to sample a portion of an RF Tx signal transmitted to antenna, such as transmit antenna 205A, from the transmit signal chain 220. The sampled RF Tx signal can then be transmitted over the transmission line 255 to the receive signal chain 230 for processing, such as to evaluate the fidelity of the RT Tx signal.

The baseband processing circuitry 294 can be an example of the baseband processing circuitry 110 (FIG. 1A). In some aspects, the baseband processing circuitry 294 can transmit a baseband signal, such as a baseband signal modulated with data or a specified test sequence, to the transmit signal chain 220. In some aspects, the baseband processing circuitry can include circuitry for determining the quality of a transmitter or the fidelity of an RF signal generated by the transmitter. In certain aspects, the transmit signal chain 220 can be an example of the transmit circuitry 115 (FIG. 1A), improved with a feedback receiver path, such as feedback receiver attenuator 235, low noise amplifier (LNA) 240 and feedback power processing circuitry 245. The transmit circuitry 255 can convert the received baseband signal to an RF Tx signal. The RF Tx signal can then be amplified, such as by power amplifier 250, and transmitted to an antenna 205A, such as a transmit antenna in the antenna array 130 (FIG. 1A).

The coupler 210, the feedback receiver attenuator 235, and the feedback processing circuitry 245 can form a feedback receiver path. The coupler 210 can sense the RF Tx signal transmitted from the transmit signal chain 220, such as by using coupling element 210A (e.g., a specifically configured transformer, or another coupling device), and transmit an attenuated version, or sample, of the RF Tx signal to the feedback receiver attenuator 235. In some aspects, the sensed RF Tx signal can be attenuated using an adjustable coupler attenuator 210 (or, generally, an adjustable attenuator 210). The feedback receiver attenuator 235 can amplify or attenuate the sensed RF Tx signal to a maintain a specified signal level at the output of the feedback receiver attenuator. In some aspects, a portion of the output of the feedback receiver attenuator 235 can be processed by feedback power processing circuitry 245 according to known feedback receiver path processing techniques. According to other aspects, the output of the feedback attenuator 235 can be amplified by a low-noise amplifier (LNA) 240 and transmitted to the transmission line 255. The LNA 240 can be a wideband amplifier having an adaptable or adjustable frequency response, as described herein. The transmission line 255 can couple the output of the LNA 240 from a transmitter side of the millimeter wave communication device 200 (or transceiver) to the receiver side of the device.

The RF circuitry 225 illustrates aspects of the RF circuitry 125 (FIG. 1A), such as an LNA 260 and an LNA 265. The LNA 260 can be a low-noise amplifier configured to amplify a signal received from a receive antenna (e.g., antenna 205B), such as to transmit the amplified signal to the receive signal chain 230 for processing. The LNA 265 can be a constant gain wideband amplifier configured to receive and amplify a differential input RF signal received from the transmission line 255. The LNA 265, for example can be configured to operate over a frequency band of two to three octaves. The output of the LNA 265 can be transmitted to a mixer 270 in the receive chain 230. In some aspects the receive chain 230 can include one or more circuits to multiplex that outputs of the LNA 260 and the LNA 265. Such multiplexing can cause the mixer 270 to receive the output of the LNA 260 while the millimeter wave communication device 200 is operating in a normal operating mode. Such multiplexing can also cause the mixer 270 to receive the output of the LNA 265 while the millimeter wave communication device 200 is operating in a test or diagnostic mode. Such multiplexing can be controlled by one or more control circuits, such as the protocol processing circuitry 105 (FIG. 1A).

The mixer 270 can include one or more sets of frequency, or signal, mixer circuits to convert an RF signal to a baseband signal using an unmodulated local oscillator 292. Such converting can include intermediate steps, such as first converting the RF signal to an intermediate frequency (IF) signal, followed by converting the IF signal to a baseband signal. While the millimeter wave communication device 200 is operating in a test mode, the mixer 270 can convert the RF Tx signal received from LNA 265 to a baseband signal using local oscillator 292. The baseband signal can be processed using the receive signal chain 230. Such processing can include converting a voltage-mode baseband output of the mixer 270 to a current-mode baseband signal using baseband gain circuitry 275 (e.g., a voltage to current amplifier), and converting the current-mode baseband signal to a digital baseband signal using an analog-to-digital converter (ADC) 280. Such processing can further include conditioning the digital baseband signal using receiver digital front-end circuitry 285, and transmitting the conditioned digital baseband signal to baseband processing circuitry 294 through an RF integrated circuit to baseband integrated circuit interface circuitry 290. The baseband processing circuitry 294 can perform additional processing to characterize the fidelity of the RF Tx signal, as described herein. In some aspects, the base processing circuitry 294 can provide feedback based on the additional procession to one or more other circuits, such as power processing circuitry 245 and transmit circuitry 255. Such feedback can be used to determine or adjust the quality of the transmit signal chain 220.

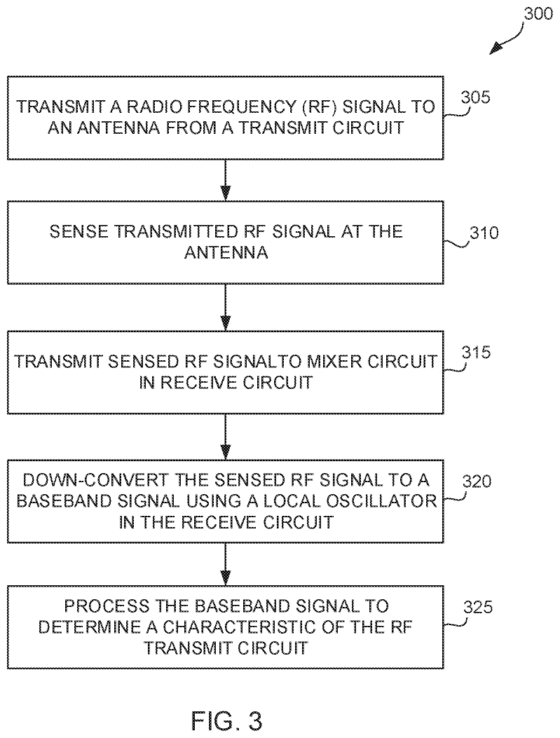

FIG. 3 illustrates a flowchart of a set of operations 300 for operating a millimeter wave communication device having circuits for self-evaluating the fidelity of a radio frequency transmit signal, according to various aspects. Such millimeter wave communication device may be an example of the millimeter wave communication device 100 (FIG. 1A) or the millimeter wave communication device 200 (FIG. 2). At operation 305, an RF signal can be transmitted to an antenna, such as a transmit antenna in antenna array 130 (FIG. 1A). The RF signal can be transmitted by a transmit signal chain associated within the millimeter wave communication device, as described herein. At operation 310, the RF signal can be sensed, such as by a coupler at the output of the transmit signal chain, or at the output of an RF circuit such as the RF circuitry 125 (FIG. 1A).

At operations 315 and 320, the sensed RF signal can be transmitted to a mixer circuit in a receive circuit, such as the receiver chain 230 (FIG. 2), such as to generate a modulated baseband signal. Transmitting the sensed RF signal can include conditioning a portion of the sensed RF signal using one or more circuits, such as feedback receiver attenuator or an LNA. Such conditioning can include amplifying the sensed RF signal using the LNA. Transmitting the sensed RF signal can also include transmitting the conditioned RF signal to a transmission line coupled to the receiver circuit. Generating the modulated baseband signal can include down-converting the RF signal received at the mixer by mixing the RF signal with an unmodulated signal generated by a local oscillator circuit in the receiver circuit.

At operation 325, the modulated baseband signal can be further processed to determine a characteristic of the transmitter circuit. Such processing can include recovering digital baseband data modulating the transmitted radio frequency signal and comparing the recovered data to known data.

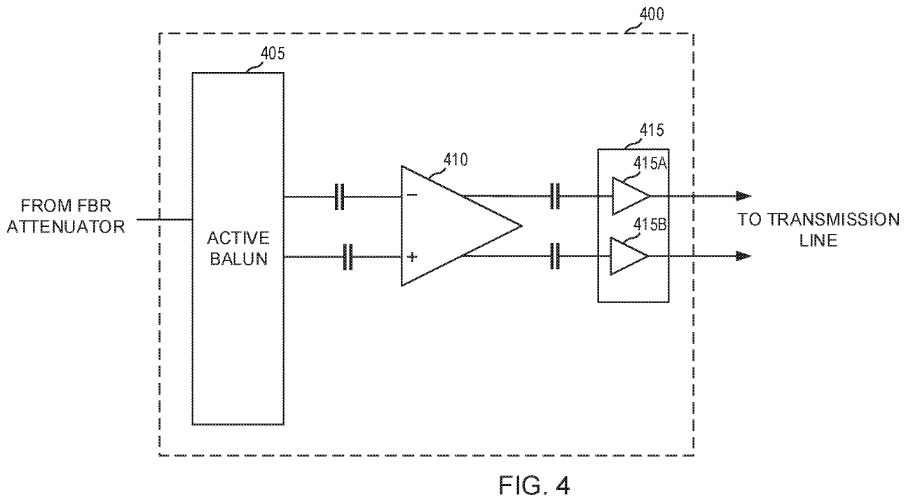

FIG. 4 illustrates a diagram of an example of a wideband low-noise amplifier (LNA) 400 for driving a transmission line, according to some aspects. The wideband LNA 400 (hereinafter, LNA 400) can be an example of the LNA 240 (FIG. 2). The LNA 400 can be configured to operate over a band of frequencies that can vary from 600 megahertz to 6 GHz. In some aspects, the LNA 400 can be configured to operate at higher frequencies (e.g., frequencies of 30 GHz or higher. The active balun 405 can receive a single-ended RF signal, such as from the feedback receiver attenuator 235 (FIG. 2), such as to generate an isolated differential RF signal. The differential RF signal can be coupled to a differential amplifier 410, such as to amplify and balance the differential RF signal. The output of the differential amplifier 405 can be transmitted to a transmission line by output buffer circuit 415. The output buffer circuit 415 can include transmission line drivers 415A and 415B, each configured to drive a component, or end, of the differential RF out of the differential amplifier 410. The line driver 415A and 415B can each have an adjustable output impedance and an independently adjustable peaking amplitude and frequency.

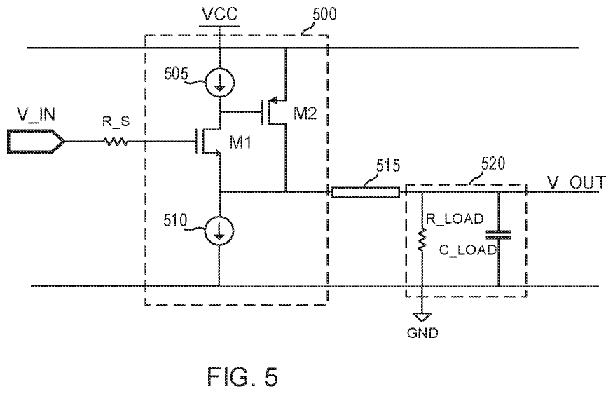

FIG. 5 illustrates a diagram of an example of a line driver 500 within an output stage of low noise amplifier, such as the LNA 400 (FIG. 4), according to some aspects. The line driver 500 can be an example of the transmission line driver 415A and 415B (FIG. 4). In some aspects, the line driver 500 can have a source resistance R_S. In certain aspects, the line driver 500 can have an output coupled to a transmission line 515 and a load 520 having resistive component R_Load and capacitive component C_Load. The transmission line 515 can be an example of the transmission line 255 (FIG. 2).

The line driver 500 can include a FET source follower such as a N-type FET (NFET) source follower formed by an NFET M1, a current source 505, and a current source 510. In some aspects, the current source 505 and the current source 510 can include one or more transistors, such as a FET constant current source or a current mirror. In some aspects, the current supplied by the current source 505 can be automatically or manually adjusted in response to a frequency of an input signal V_IN, such as by using a lookup table, a function, or other relationship to determine a reference current or voltage value for the current source. Such adjusting can also include using the lookup table, function, or other relationship to determine, or set, a size of one or more FETs in the current source 505, such as by selectively coupling one or more FETs in parallel to increase an effective size of one or more sourcing FETs.

The line driver 500 can also include a FET coupled to M1, such as a M2, such as to form a negative feedback loop between the drain and source of M1, such as to adjust the output impedance and the output resistance of the source follower in response to the frequency V_IN, such as to improve gain flatness over a wide frequency band. While M1 is drawn as an N-type FET (NFET) and M2 is drawing as P-type FET, it is understood that the present disclosure applies to other configurations so long as M1 and M2 are complementary. The transistor M1, for example can be a P-type FET (PFET) while M2 can be an NFET. The negative feedback loop can lower the output impedance and the output resistance using less supply current than would be required by other source followers. Generally, the output impedance and the output resistance of the source follower can be reduced, as compared to source followers that do not use the local negative feedback loop depicted in FIG. 5, by a factor of (1+gm₂·R_{DS}), where gm₂ is the transconductance of M2, and R_{DS} is the drain to source resistance of a FET current source 505.

The line driver 500 can be configured to drive the load 520 at the end of the transmission line 515 using signals that can have a frequency ranges of two or more octaves. The output characteristics of the line driver 500 can be adapted, or adjusted, to drive the load 520 over such a frequency range. Such adjusting can include lowering the output inductance and resistance of the line driver 500 as input increases in the frequency of V_IN. Such adjusting can also include independently adjusting peaking amplitude and peaking frequency by adjusting the ratio of transconductance of the M1 (gm₁) to the transconductance of M2 (gm₂), such as by changing the aspect ratio (the ratio of transistor width to length) of M2 or by adjusting the current supplied by the current source 505. In some aspects, the aspect ratio of M2 can be adjusted, automatically or manually, using a lookup table, a function, or other techniques, to determine the size of M2 as a function of the frequency of V_IN. In certain aspects, a lookup table, function, or other relationship, can to be used to selectively couple one or more unit FETs in parallel to form an effective FET M2 of a desired size.

According to various aspects, adjusting the amount of current sourced by current source 505 can adjust the peaking amplitude at load 520. Additionally, adjusting the size of M2 can change the peaking frequency of the line driver 500. As an example, increasing the current supplied by the current source 505 can increase the peaking amplitude, while increasing the size of M2 relative to the size of M1 can increase the peaking frequency.

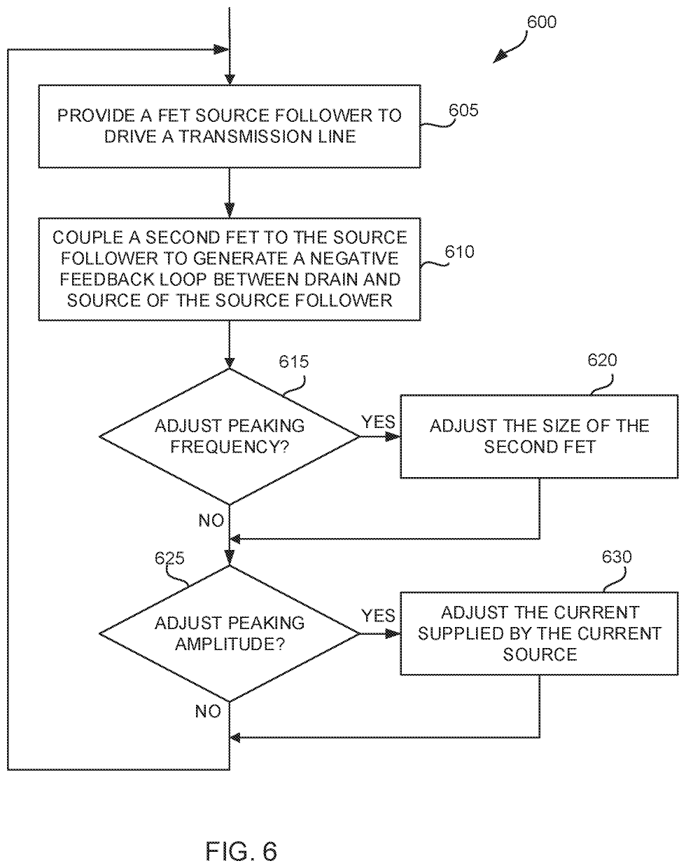

FIG. 6 illustrates a flowchart of a set of operations 600 for operating a line driver within an output stage of low-noise amplifier, according to some aspects. At operation 605, a source-follower circuit can be provided, such as to drive a transmission line. The source follower can include a transistor such as a first FET, a first current source coupled to a drain of the first FET, and a second current source coupled to the source of the first FET. At operation 610, a second transistor such as a complementary second FET can be coupled to the source-follower, such as to generate a negative-feedback control loop. The negative feedback loop can include a first node comprising the drain of the first FET and a base of the second FET, and a second node comprising the source of the first FET and a drain of the second FET. Either the size of the second FET or the current supplied by the first current source, or both, can be adjusted to satisfy a specified output signal characteristic of the line driver. Such output signal characteristic can include a peaking frequency or a peaking amplitude. As an example, at operation 615, a determination can be made as to whether to adjust the peaking frequency of the line driver, such as in response to a frequency of an input signal or an operating frequency band of the line driver. At operation 620, the peaking frequency can be adjusted by decreasing the size of the second FET to increase peaking frequency, or by increasing the size of the second FET to decrease peaking frequency. As another example, at operation 625, a determination can be made as to whether to adjust the peaking amplitude of the line driver. At operation 630, the peaking amplitude can be adjusted by increasing the amount of current sourced by the first current source to increase peaking amplitude, while the amount of current sourced by the first current source can be decreased to reduce peaking amplitude.

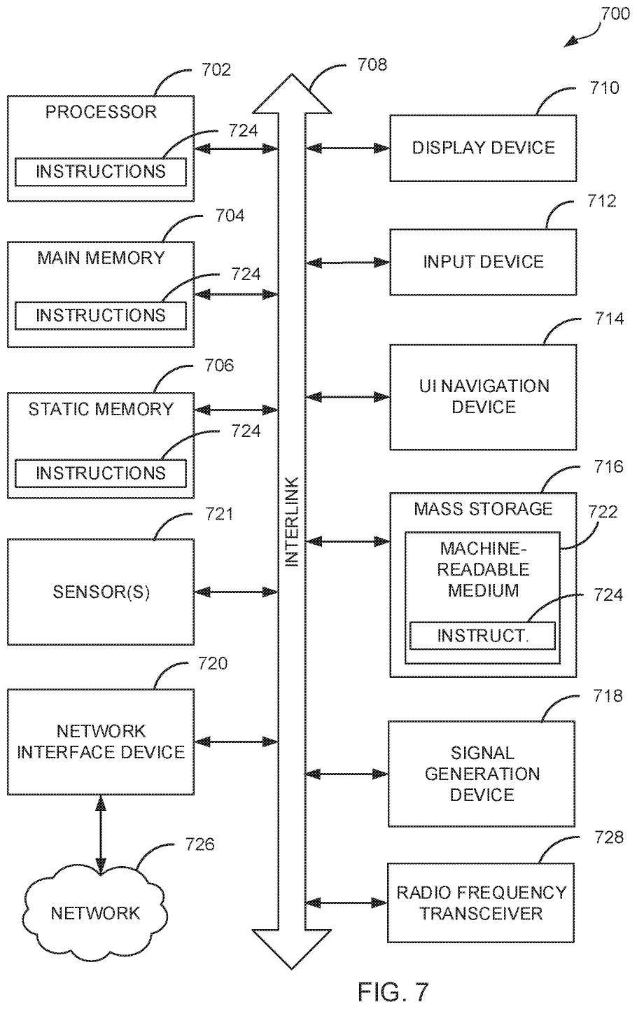

FIG. 7 is a block diagram illustrating an example of an electronic device 700 that can include a millimeter wave radio communication device 728, such as a transceiver, having circuits for self-evaluating the fidelity of a radio frequency transmit signal, according to various aspects. In alternative aspects, the electronic device operates as a standalone device or may be connected (e.g., networked) to other electronic devices. In a networked deployment, the electronic device may operate in the capacity of either a server or a client electronic device in server-client network environments, or it may act as a peer electronic device in peer-to-peer (or distributed) network environments. The electronic device may be a head-mounted display, wearable device, personal computer (PC), a tablet PC, a hybrid tablet, a personal digital assistant (PDA), a mobile telephone, or any electronic device capable of executing instructions (sequential or otherwise) that specify actions to be taken by that electronic device. Further, while only a single electronic device is illustrated, the term “electronic device” shall also be taken to include any collection of electronic devices that individually or jointly execute a set (or multiple sets) of instructions to perform any one or more of the methodologies discussed herein. Similarly, the term “processor-based system” shall be taken to include any set of one or more electronic devices that are controlled by or operated by a processor (e.g., a computer) to individually or jointly execute instructions to perform any one or more of the methodologies discussed herein.

Example electronic device 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The electronic device 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The electronic device 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor. The computing system may further include a radio frequency communication device or transceiver 728. The radio frequency communication device or transceiver 728 can be an example of a millimeter wave communication device as discussed in the figures.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the electronic device 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the electronic device and that cause the electronic device to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTEILTE-A, 5G, DSRC, or WiMAX networks). The term “transmission medium” shall be taken to include any intangible medium that is capable of storing, encoding, or carrying instructions for execution by the electronic device, and includes digital or analog communications signals or other intangible medium to facilitate communication of such software.

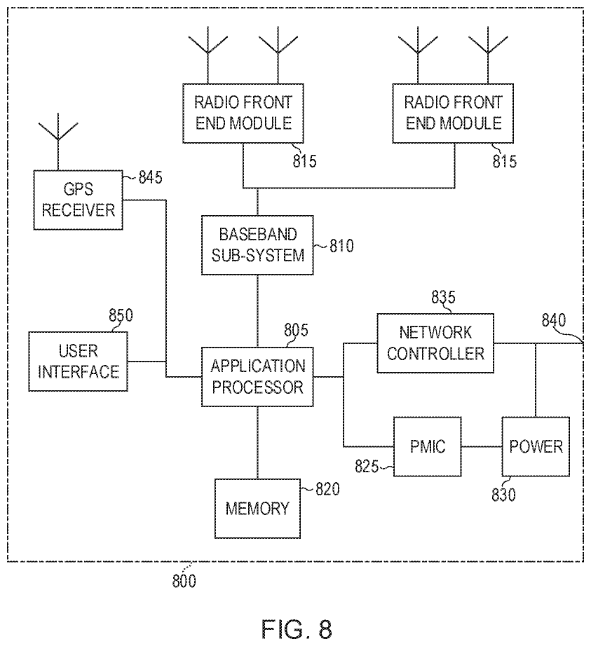

FIG. 8 illustrates an exemplary base station or infrastructure equipment radio head according to some aspects. The base station radio head 800 may include one or more of application processor 805, baseband processors 810 such as the baseband circuitry 110 (FIG. A1) and protocol processing circuitry 105 (FIG. 1A), one or more radio front end modules 815, memory 820, power management integrated circuitry (PMIC) 825, power tee circuitry 830, network controller 835, network interface connector 840, satellite navigation receiver (e.g., GPS receiver) 845, and user interface 850. In some aspects the one or more radio front end modules 815 can include a millimeter wave communication device such as the device described in the figures.

In some aspects, application processor 805 may include one or more CPU cores and one or more of cache memory, low drop-out voltage regulators (LDOs), interrupt controllers, serial interfaces such as SPI, I2C or universal programmable serial interface, real time clock (RTC), timer-counters including interval and watchdog timers, general purpose IO, memory card controllers such as SD/MMC or similar. USB interfaces, MIPI interfaces and Joint Test Access Group (JTAG) test access ports.

In some aspects, baseband processor 810 may be implemented, for example, as a solder-down substrate including one or more integrated circuits, a single packaged integrated circuit soldered to a main circuit board or a multi-chip sub-system including two or more integrated circuits.

In some aspects, memory 820 may include one or more of volatile memory including dynamic random access memory (DRAM) and/or synchronous DRAM (SDRAM), and nonvolatile memory (NVM) including high-speed electrically erasable memory (commonly referred to as Flash memory), phase-change random access memory (PRAM), magnetoresistive random access memory (MRAM), and/or a three-dimensional crosspoint memory. Memory 820 may be implemented as one or more of solder down packaged integrated circuits, socketed memory modules and plug-in memory cards.

In some aspects, power management integrated circuitry 825 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 830 may provide for electrical power drawn from a network cable. Power tee circuitry 830 may provide both power supply and data connectivity to the base station radio head 800 using a single cable.

In some aspects, network controller 835 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver 845 may include circuitry to receive and decode signals transmitted by one or more navigation satellite constellations such as the global positioning system (GPS). Globalnaya Navigatsionnaya Sputnikovaya Sistema (GLONASS). Galileo and/or BeiDou. The receiver 845 may provide, to application processor 805, data which may include one or more of position data or time data. Time data may be used by application processor 805 to synchronize operations with other radio base stations or infrastructure equipment.

In some aspects, user interface 850 may include one or more of buttons. The buttons may include a reset button. User interface 850 may also include one or more indicators such as LEDs and a display screen.

The above detailed description includes references to the accompanying drawings, which form a part of the detailed description. The drawings show, by way of illustration, specific aspects that may be practiced. These aspects are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “r” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third.” etc. are used merely as labels, and are not intended to suggest a numerical order for their objects.

The above description is intended to be illustrative, and not restrictive. For example, the above-described examples (or one or more aspects thereof) may be used in combination with others. Other aspects may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as aspects may feature a subset of said features. Further, aspects may include fewer features than those disclosed in a particular example. Thus, the following claims are hereby incorporated into the Detailed Description, with a claim standing on its own as a separate embodiment. The scope of the aspects disclosed herein is to be determined with reference to the appended claims, along with the full scope of equivalents to which such claims are entitled.

1. A radio communication device, comprising:
a device substrate;
a transmitter circuit coupled to the device substrate, wherein the transmitter circuit is configured to transmit a radio frequency signal to an antenna;
a receiver circuit coupled to the device substrate, wherein the receiver circuit has an oscillator circuit to generate a baseband signal from a received radio frequency signal; and
a feedback circuit coupled to the antenna and the receiver circuit, wherein the feedback circuit is configured to couple a portion of the transmitted radio frequency signal to the oscillator circuit using a transmission line.

2. The radio communication device of claim 1, wherein the feedback circuit comprises a coupler circuit, wherein the coupler circuit is configured to:
sense the transmitted radio frequency signal, and
condition the sensed transmitted radio frequency signal to generate the portion of the transmitted radio frequency signal.

3. The radio communication device of claim 1, wherein the feedback circuit comprises a driver circuit configured to transmit the portion of the transmitted radio frequency signal to the transmission line, wherein the transmission line is coupled to the oscillator circuit.

4. The radio communication device of claim 3, wherein the driver circuit is a wideband amplifier.

5. The radio communication device of claim 1, wherein the receiver circuit comprises a wideband buffer circuit configured to couple the portion of the transmitted radio frequency signal from the transmission line to the oscillator circuit.

6. The radio communication device of claim 1, wherein the transmission line has a physical length, wherein the physical length is longer than a threshold.

7. The radio communication device of claim 1, wherein the transmission line has an electrical length, wherein the electrical length is indicated by a carrier frequency of the radio frequency signal, wherein the carrier frequency is selectable from a band of frequencies, wherein the band of frequencies has a bandwidth of at least two octaves.

8. The radio communication device of claim 1, wherein the oscillator circuit is configured to convert the portion of the transmitted radio frequency signal to a modulated baseband signal.

9. The radio communication device of claim 1, wherein the transmitted radio frequency signal is polar modulated.

10. The radio communication device of claim 1, further comprising a control circuit configured to alternatively couple the portion of the transmitted radio frequency signal and a received radio frequency signal to the oscillator circuit.

11. The radio communication device of claim 1, wherein the receiver circuit further comprises baseband processing circuits to convert a modulated baseband signal generated by the oscillator circuit to a digital baseband signal.

12. The radio communication device of claim 1, wherein the oscillator circuit is configured to generate a modulated baseband signal based on the portion of the transmitted radio frequency signal, wherein the receiver circuit is configured to generate a digital baseband signal based on a modulated baseband, further comprising a control circuit configured to determine a characteristic of the transmitter circuit based on the modulated baseband signal.

13. The radio communication device of claim 12, wherein the characteristic of the transmitter circuit is at least one of an adjacent channel leakage ratio and a quality of the transmitter circuit.

14. A method for operating a radio transceiver circuit to test a transmitter circuit within the radio transceiver circuit, the method comprising:
transmitting a radio frequency signal to an antenna;
sensing a portion of the transmitted radio frequency signal;
transmitting the sensed portion of the transmitted radio frequency signal to a frequency mixer circuit in a receiver circuit of the radio transceiver circuit to generate a modulated baseband signal;
processing the modulated baseband signal to recover digital baseband data that was used to modulate the transmitted radio frequency signal; and
determining a characteristic of the transmitter circuit using the digital baseband data and a processing circuit coupled to the radio transceiver circuit.

15. The method of claim 14, wherein said transmitting the sensed portion of the transmitted radio frequency signal to the frequency mixer comprises:
conditioning the sensed portion of the transmitted radio frequency signal using a driver circuit, to obtain a conditioned signal; and
transmitting the conditioned signal to a transmission line coupled to the receiver circuit.

16. The method of claim 15, wherein said conditioning the sensed portion of the transmitted radio frequency signal comprises amplifying the sensed portion of the transmitted radio frequency signal using a wideband amplifier, wherein the wideband amplifier is configured to operate over a frequency band having a bandwidth greater than a threshold bandwidth.

17. The method of claim 15, wherein said generating the modulated baseband signal comprises mixing the conditioned signal with an unmodulated signal generated by an oscillator of the receiver circuit.

18. A system, comprising:
a transmitter circuit coupled to a substrate;
a receiver circuit coupled to the substrate, the receiver circuit comprising:
a frequency mixer circuit;
and one or more baseband processing circuits;
a feedback circuit configured to couple an output of the transmitter circuit to the frequency mixed circuit, the feedback circuit comprising:
a transmission line,
a coupler circuit coupled to the output of the transmitter circuit, a driver circuit coupled to coupler circuit and to a transmission line, and
a buffer circuit coupled to the transmission line and the frequency mixer circuit, the frequency mixer circuit configured to selectively receive an input from the buffer circuit and a receive antenna.

19. The system of claim 18, wherein the frequency mixer circuit is configured to convert a radio frequency signal to a baseband signal using an unmodulated oscillator circuit.

20. The system of claim 18, wherein the transmitter circuit is configured to generate a polar modulated radio frequency signal.

21-30. (canceled)
